(19) United States
(12) Patent Application Publication
(10) Pub. No.: US 2009/0154198 A1
(43) Pub. Date: Jun. 18, 2009

(54) REFLECTION TYPE DISPLAY APPARATUS

(76) Inventors: Joo Hoon LEE, Yongin-si (KR); Sun Tae JUNG, Yongin-si (KR); Yu Sheop LEE, Suwon-si (KR)

Correspondence Address: CHA & REITER, LLC, 210 ROUTE 4 EAST STE 103, PARAMUS, NJ, 07652, US

(21) Appl. No.: 12/334,744

(22) Filed: Dec. 15, 2008

(30) Foreign Application Priority Data
Dec. 14, 2007 (KR) 2007-0130564
Mar. 25, 2008 (KR) 2008-0027234

(51) Int. Cl. F21V 13/02; F21V 8/00

(52) U.S. Cl. 362/624; 362/627

(57) ABSTRACT

A reflection type display apparatus has a front light unit (FLU), and includes a display panel, a light guide disposed on the upper surface of the display panel, a light transparent adhesive layer attaching the lower surface of the light guide to the upper surface of the display panel, and a light source located at a side of the light guide for emitting light to the light guide. A protection window covers the light guide and the light source. By covering the display panel installed on the lower surface of the protection window and the light guide with a moisture-proof and light-shield film, moisture-proofing and light-shielding effects are obtained simultaneously. Further, by forming a light absorption layer at the edge of the light guide adjacent to the light source, generation of a hot spot at the edge of the light guide may be inhibited.

### CLAIM OF PRIORITY

This application claims priority under 35 U.S.C. §119 from an application entitled “REFLECTION TYPE DISPLAY APPARATUS” filed in the Korean Intellectual Property Office on Dec. 14, 2007 and assigned Serial No. 2007-0130564, and from application Serial No. 2008-0027234 filed Mar. 25, 2008, also named as above, the contents of both applications are hereby incorporated herein by reference in their entirety.

### BACKGROUND OF THE INVENTION

1. Field of the Invention

The present invention relates to a reflection type display apparatus. More particularly, the present invention relates to a reflection type display apparatus having a front light unit.

2. Description of the Related Art

A reflection type display apparatus displays an image by reflecting sun light or external illumination light at a display panel. Because the reflection type display apparatus cannot display an image in a dark place where an external light is unavailable, a model having a front light unit (hereafter, FLU) is now provided as a self-illuminating means for displaying an image in a dark place and is being marketed. The FLU is configured with a light guide and a light source installed at a side of the light guide.

The reflection type display apparatus having the FLU described above has a structure such that the light source is installed at a side of the light guide. The display panel and a protection window are disposed such that air layers are formed at upper and lower surfaces of the light guide. A reflection pattern is formed on the upper surface or the lower surface of the light guide for reflection of light guided through the light guide. The air layers are formed at the upper and lower surfaces of the light guide so as to display a clear image by minimizing the critical angle of total reflection of incident light emitted by the light source to the side of the light guide. That is, the amount of incident light guided through the light guide increases when the critical angle of total reflection decreases. Accordingly, a sufficient amount of light reflected by the reflection pattern of the light guide can be ensured, and thereby a clear image can be displayed by the display panel.

However, there is a problem with the reflection type displays in that the quality of a displayed image deteriorates due to the reflection pattern formed in the light guide being visible while displaying an image in the display panel, because the difference between refractive indices of the light guide and the air layer is great.

Conventional reflection type display apparatus has multiple interfaces arranged between the display panel, air layer, light guide, air layer, and protection window. When illuminating the display panel with an external light, light emitted by the external light must pass through the interfaces having greatly different refractive indices until leaving the display panel. Therefore, illumination efficiency is decreased and image quality may deteriorate due to light reflected by the protection window and the light guide.

Furthermore, because air layers are formed at the upper and lower surfaces of the light guide, the air layer may become contaminated with foreign materials acting as a scattering source, such as moisture and dust, and thereby image quality may deteriorate over time.

Furthermore, the manufacturing process of the reflection type display apparatus having an FLU is complex, because the display panel, light guide, and protection window must be assembled maintaining a uniform air layer at the upper and lower surfaces of the light guide. In particular, when assembling a reflection type display apparatus having a flexible display panel, light guide, and protection window, it is difficult to maintain a stable structure between the display panel, light guide, and protection window due to deformation of the reflection type display apparatus. In other words, according to the extent of deformation of the reflection type display apparatus, the thickness of the air layer may vary; or the air layer may be eliminated if the light guide directly contacts the display panel or the protection window.

A portion of incident light emitted by the light source may be incorrectly guided into the light guide and then leaks through the edge of the light guide adjacent to the light source. Accordingly, a “hot spot” phenomenon may occur in which the edge of light guide adjacent to the light source appears brighter than other portion of the light guide.

### SUMMARY OF THE INVENTION

The present invention provides a reflection type display apparatus that reduces deterioration of image quality due to a reflection pattern of a light guide.

The present invention also provides a reflection type display apparatus with reduced chance of contamination of a light guide and the deterioration of image quality due to air layers formed at both side of the light guide.

The present invention also provides a reflection type display apparatus that provides flexibility of the reflection type display apparatus while maintaining uniform interfaces between a display panel, light guide, and protection window.

The present invention also provides a reflection type display apparatus that inhibits leakage of light through a side of a light guide.

Moreover, the present invention provides a reflection type display apparatus that inhibits generation of a hot spot at the edge of a light guide adjacent to a light source.

In an exemplary aspect of the present invention, a reflection type display apparatus according to the present invention may include: a display panel; a light guide disposed on the upper surface of the display panel; a light transparent first adhesive layer attaching the lower surface of the light guide to the upper surface of the display panel; and a light source located at a side of the light guide for emitting light to the light guide.

The reflection type display apparatus may further include a protection window installed maintaining a predetermined distance from the upper surface of the light guide, and can be attached to the upper surface of the light guide through a light transparent second adhesive layer.

In the reflection type display apparatus, the first and second adhesive layers have a refractive index less than a refractive index of the light guide.

In the reflection type display apparatus, the display panel, light guide, and protection window may be flexible.

The reflection type display apparatus may further include a moisture-proof light-shield film covering the display panel installed on the lower surface of the protection window and the outer side surfaces of the light guide.

A light absorption layer may be formed at the edges of the upper and lower surfaces of the light guide adjacent to the light source.

According to another exemplary embodiment of the present invention includes: a reflection type display includes a display panel; a light guide disposed maintaining a predetermined distance from the upper surface of the display panel; a light source located at a side of the light guide and for emitting light to the light guide; a protection window disposed on the upper surface of the light guide; and a light transparent adhesive layer attaching the lower surface of the protection window to the upper surface of the light guide.

According to an exemplary aspect of the present invention, at least one interface between a display panel, light guide, and protection window is formed by an adhesive layer, wherein the structure is advantageous because deterioration of image quality due to a reflection pattern of a light guide can be reduced over reflection panels known heretofore. Because the difference of refractive indices between the light guide and the adhesive layer is less than the difference of refractive indices between the light guide and an air layer, the reflection pattern of the light guide is scarcely visible from the outside. Accordingly, deterioration of image quality due to appearance of the reflection pattern of the light guide can be inhibited as compared with known reflection panels.

The adhesive layer formed at the upper surface or the lower surface of the light guide may reduce contamination of the light guide and deterioration of image quality compared to an air layer.

In an exemplary aspect of the present invention, by attaching a display panel and a protection window to opposite surfaces of the light guide with an adhesive layer, and by using a flexible material for each component, the reflection type display apparatus may maintain a high flexibility and uniform interfaces between the light guide, display panel, and protection window. Due to the fact that the adhesive layers exist between the light guide, display panel, and protection window, illumination efficiency can be improved as compared with a case of an air layer existing when the display panel is illuminated by an external light.

By covering the display panel installed on the lower surface of the protection window and the light guide with a moisture-proof light-shield film, moisture-proofing and light-shielding effects can be obtained simultaneously.

Further, by forming a light absorption layer at the edges of the upper and lower surfaces of the light guide adjacent to the light source, generation of a hot spot at the edge of the light guide may also be inhibited.

### BRIEF DESCRIPTION OF THE DRAWINGS

The objects, features and advantages of the present invention will become more apparent from the following detailed description in conjunction with the accompanying drawings, in which:

FIG. 1 is a schematic side view of a reflection type display apparatus having an FLU according to a first exemplary embodiment of the present invention;

FIG. 2 is a schematic side view of a reflection type display apparatus having an FLU according to a second exemplary embodiment of the present invention;

FIG. 3 is a schematic side view of a reflection type display apparatus having an FLU according to a third exemplary embodiment of the present invention;

FIG. 4 is a schematic side view showing a flow of light emitted by the light source in the reflection type display apparatus of FIG.3;

FIG. 5 is a schematic plan view of a reflection type display apparatus having an FLU according to a fourth exemplary embodiment of the present invention;

FIG. 6 is a partial sectional view cut along the line VI-VI of FIG. 5;

FIG. 7 is a schematic plan view of a reflection type display apparatus having an FLU according to a fifth exemplary embodiment of the present invention;

FIG. 8 is a partial sectional view cut along the line VIII-VIII of FIG. 7;

FIG. 9 is a schematic side view of a reflection type display apparatus having an FLU according to a sixth exemplary embodiment of the present invention; and

FIG. 10 is a schematic plan view of a reflection type display apparatus having an FLU according to a seventh exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts. The views in the drawings are schematic views only, and are not necessarily drawn to scale or in proportion. Detailed descriptions of well-known functions and structures incorporated herein may be omitted to avoid obscuring appreciation of the subject matter of the present invention by a person of ordinary skill in the art.

Referring to FIG. 1, a reflection type display apparatus 100 having an FLU according to a first exemplary embodiment of the present invention includes a display panel 10, light guide 20, light source 40, and protection window 50, wherein the lower surface of the light guide 20 is attached to the upper surface of the display panel 10 by a light transparent adhesive layer 31.

The display panel 10 displays an image by using at least one of external light or light emitted by the light source 40. The display panel 10 may comprise, for example, a liquid crystal panel or an electronic paper, and in the first exemplary embodiment the display panel 10 is preferably embodied as an electronic paper of an electrophoresis type utilizing electrophoresis and a micro capsule. Thereto, the display panel 10 includes a transparent substrate 14 having an transparent electrode 13 plated on its lower surface, an electronic ink layer 12 coated over the transparent electrode 13 on the lower surface of the transparent substrate 14, and an electrode substrate 11 attached to the lower surface of the electronic ink layer 12. An upper moisture-proof film 15 is attached to the upper surface of the transparent substrate 14 and a lower moisture-proof film 16 is attached to the lower surface of the electrode substrate 11.

One particular example of using an electronic paper of an electrophoresis type is disclosed in the first exemplary embodiment, however the present invention is in no way limited thereto the invention can include virtually any of the various electronic paper technologies. For example, an electronic paper of a twist ball type utilizing an electrostatically charged semi-spherical twist ball or an electronic paper of a cholesterol liquid crystal type may also be used.

The light guide 20 is disposed on the upper surface of the display panel 10, and the lower surface of the light guide is attached to the upper surface of the display panel 10 using the adhesive layer 31. The light source 40 is located adjacent to a side of the light guide 20, and emits incident light to the light guide 20. The light source 40 and the light guide 20 are disposed at as small a separation as possible to improve light reception efficiency. When considering a tolerance in an assembly process, the distance between the light source 40 and the light guide 20 is preferably less than 0.2 mm.

The light source 40 may be, for example a cold cathode fluorescence lamp (CCFL) of an electron emitting system utilizing an electric field, an external electrode fluorescent lamp (EEFL), or an LED (light emitting diode). An example of installing the light source 40 at one side of the light guide 20 is disclosed in the first exemplary embodiment; however the present invention is not in any way limited thereto. For example, the light source 40 may be installed at opposite sides of the light guide 20. It is also within the scope of the present invention to install the light source in a different position and provide a series of mirrors/reflectors to have the light enter the light guide at a desired position.

The light source 40 emits linear light to the light guide 20, and a reflection pattern of the light guide converts the linear light to surface light is thereby formed such that the display panel 20 emits the surface light. That is, the incident light emitted by the light source 40 is reflected to the display panel 10 by the reflection pattern of the light guide 20, and thereby illuminates the display panel 10.

The material of the light guide 20 may be highly transparent PC (polycarbonate), PET (polyethylene terephthalate), PMMA (polymethyl methacrylate), or PU (polyurethane).

The light guide 20 is manufactured in a thickness of 0.1˜0.4 mm, and in particular in a thickness of 0.1˜0.2 mm when a high flexibility is necessary. For example, in a case that the reflection type display apparatus 100 is used as a touch input display unit, the light guide 20 must be formed with a flexible material to enable a user's input operation. The thickness of the light guide 10 is preferably not less than 0.1 mm to secure the standard minimum brightness 10 nit (a unit of brightness in the MKS unit system) required in the related art. Here, the nit is a unit of brightness in the MKS unit system, indicating a surface brightness of 1 cd/m² or 10⁻⁴ sb (stilb).

Still referring to FIG. 1, the reflection pattern is formed in an area where illumination is necessary. The reflection pattern may be formed in a continuous line pattern, or, for example, in a dotted pattern, and uniformity of illumination depends upon the size and density of the reflection pattern. For example, when uniform illumination is desirable for the whole area of the display panel 10, the reflection pattern may be provided in a larger and denser form as the distance from the light source 40 becomes greater. Alternatively, when illumination is desirable for a limited area, the reflection pattern is formed such that only the limited area is illuminated. The reflection pattern may be processed in various manners, such as a screen print, stamper, prism, and V-cutting. In particular, when the thickness of the light guide 20 is in the range 0.1˜0.2 mm, the reflection pattern can be formed by using a hot stamping method.

The adhesive layer 31 may be formed by applying adhesive on the upper surface of the display panel 10 and by thermo-compressing the light guide 20. An adhesive having a refractive index less than that of the light guide 20 and having a high light transparency is used for forming the adhesive layer 31. The adhesive for forming the adhesive layer 31 preferably has a refractive index in the range 1.41˜1.45. The adhesive, for example, may be an acrylic adhesive, and may be prepared in a liquid, sheet, or double-sided adhesive tape form. There are other ways within the spirit and scope of the present to attach the light guide 20 to the display panel 10 that do not include adhesive, including mechanical attachment, including but not limited to interlocking protrusions and recesses, just to name one possible example.

The protection window 50 is installed on the light guide 20 at the opposite side to which the light guide is attached to the display panel, and covers the display panel 10, light guide 20, and light source 40. The protection window 50 is installed such that it maintains a predetermined distance from the upper surface of the light guide 20 such that an air layer 35 is formed between the protection window 50 and the light guide 20. The material of the protection window 50 may be highly transparent, for example, PC, PET, PMMA, or PU. The protection window 50 is formed in a thickness of 0.1˜1.0 mm, and in particular in a thickness of 0.1˜0.2 mm when a high flexibility is necessary.

Due to the lower surface of the light guide 20 forming an interface with the adhesive layer 31 and an interface with the air layer 35 having a lower refractive index than the adhesive layer 31, the critical angle of total reflection of the light guide 20 depends on the refractive indices of the light guide 20 and the adhesive layer 31.

In a particular example, the reflection type display apparatus 100 according to the first exemplary embodiment has a structure that the display panel 10 and the light guide 20 are attached to each other by the adhesive layer 31. The adhesive layer 31 is formed between the display panel 10 and the light guide 20 has a higher refractive index than the air layer 35, resulting in the reflection pattern of the light guide 20 being scarcely visible from the outside. Accordingly, there is a reduced deterioration of image quality due to appearance of the reflection pattern of the light guide 20.

Furthermore, the adhesive layer 31 formed between the display panel 10 and the light guide 20 serves to reduce contamination between the display panel 10 and the light guide 20, and hence reduces deterioration of the image quality. Also, the adhesive layer 31 is arranged in the interface between the display panel 10 and the light guide 20 in place of an air layer, thereby improving illumination efficiency compared with the case of an air layer existing when the display panel 10 is illuminated by an external light.

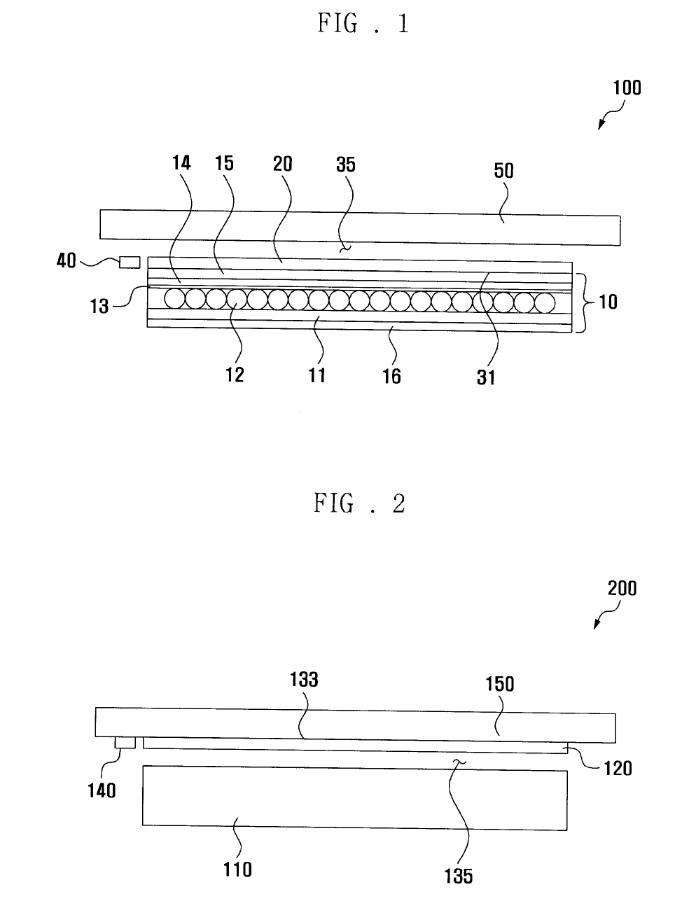

Now referring to FIG. 2, a reflection type display apparatus 200 having an FLU according to a second exemplary embodiment of the present invention has a structure that a light guide 120 and a protection window 150 are attached to each other by an adhesive layer 133. A display panel 110 may be formed from an electronic paper or a liquid crystal panel. The display panel 10 may be formed from an adhesive similar to that of the adhesive layer 31 disclosed in the first exemplary embodiment. The light guide 120 attached to the protection window 150 is installed on the display panel 110 such that the lower surface of the light guide 120 maintains a predetermined distance from the upper surface of the display panel 110, such that an air layer 135 is formed between the display panel 110 and the light guide 120.

The reflection type display apparatus 200 according to the second exemplary embodiment has a structure in which the light guide 120 and the protection window 150 are attached to each other by the adhesive layer 133. The adhesive layer 133, by being formed between the light guide 120 and the protection window 150 and has a higher refractive index than an air layer 135, results in the reflection pattern of the light guide 120 being scarcely visible from the outside. Accordingly, the deterioration of image quality due to appearance of the reflection pattern of the light guide 120 may be inhibited.

Further, the adhesive layer 133 formed between the light guide 120 and the protection window 150 may reduce contamination between the light guide 120 and the protection window 150, and hence reduce deterioration of image quality. Also, the adhesive layer 133 exists in the interface between the light guide 120 and the protection window 150 instead of an air layer, thereby improving illumination efficiency compared with the case of an air layer existing when the display panel 110 is illuminated by an external light.

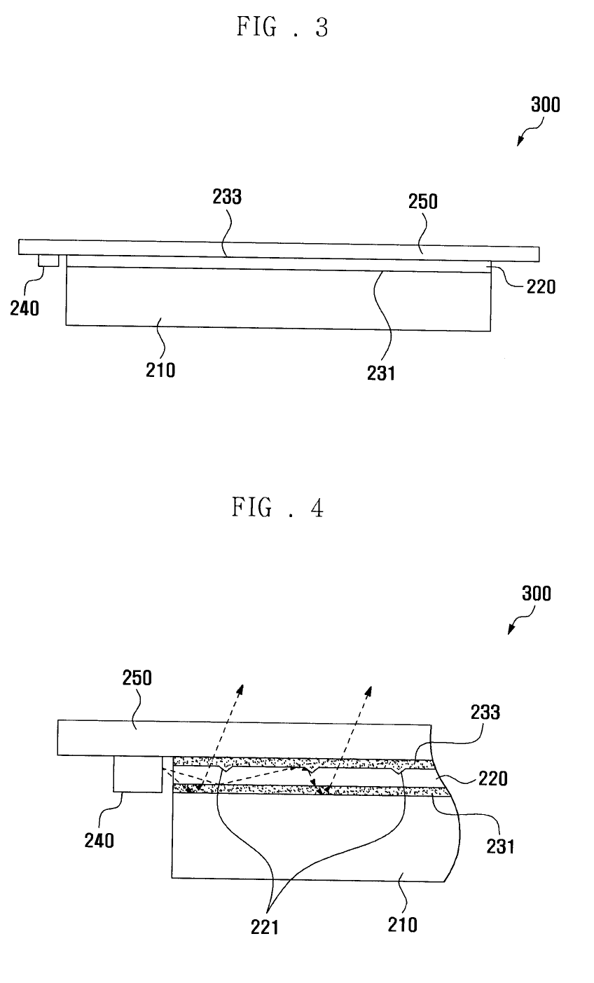

Now referring to FIGS. 3 and 4, a reflection type display apparatus 300 having an FLU according to a third exemplary embodiment has a structure that a display panel 210 is attached to a light guide 220 through a first adhesive layer 231, and the light guide 220 is attached to a protection window 250 through a second adhesive layer 233. The display panel 210, light guide 220, and protection window 250 may be manufactured with a flexible material such that the reflection type display apparatus 300 is flexible.

The display panel 210, light guide 220, and protection window 250 are attached to each other by their surfaces through the first adhesive layer 231 and the second adhesive layer 233, resulting in the reflection type display apparatus 300 maintaining flexibility and uniform interfaces between the display panel 210, light guide 220, and protection window 250.

For example, the display panel 210 can be formed from an electronic paper having a thickness, for example, of 0.5˜0.6 mm. the light guide 220 is formed from a PC film having a refractive index of 1.59 and a thickness of 0.1˜0.2 mm. The protection window 250 can be formed from a PMMA film having a thickness, for example, of 0.1˜0.2 mm. An acrylic adhesive having a refractive index of 1.41 may be used for the first adhesive layer 231 and the second adhesive layer 233. In this case, the critical angle of total reflection of the light guide 220 is about 62° when calculated by using Snell's formula. Accordingly, incident light emitted by the light source 240 to the light guide 220 having an incident angle less than the critical angle of total reflection is refracted at an interface, and thereby light refracted to the display panel 210 contributes to illumination by reflecting at the display panel 210. Incident light emitted by the light source 240 to the light guide 220 having an incident angle greater than the critical angle of total reflection is reflected at the interface and guided through the light guide 220, then contributes to illumination of the display panel 210 by reflecting at a reflection pattern 221 formed on the upper surface of the light guide 220.

In this example, the reflection pattern 221 is formed on the upper surface of the light guide 220, and because of the difference between the refractive index of the first adhesive layer 231 and that of the second adhesive layer 233 being less than the refractive index of an air layer, the result is that the reflection pattern 221 is scarcely visible, and there is a reduction in the deterioration of image quality.

According to the third exemplary embodiment, by attaching the display panel 210 and the protection window 250 at opposite surfaces of the light guide 220 by the first adhesive layer 231 and the second adhesive layer 233, respectively, and by using flexible materials, the reflection type display apparatus 300 can maintain flexibility and uniform interfaces between the display panel 210, light guide 220, and protection window 250.

Further, the first adhesive layer 231 and the second adhesive layer 233 exist at the interfaces between the display panel 210, light guide 220, and protection window 250, instead of an air layer, thereby improving illumination efficiency compared with the case of an air layer existing when the display panel 210 is illuminated by an external light.

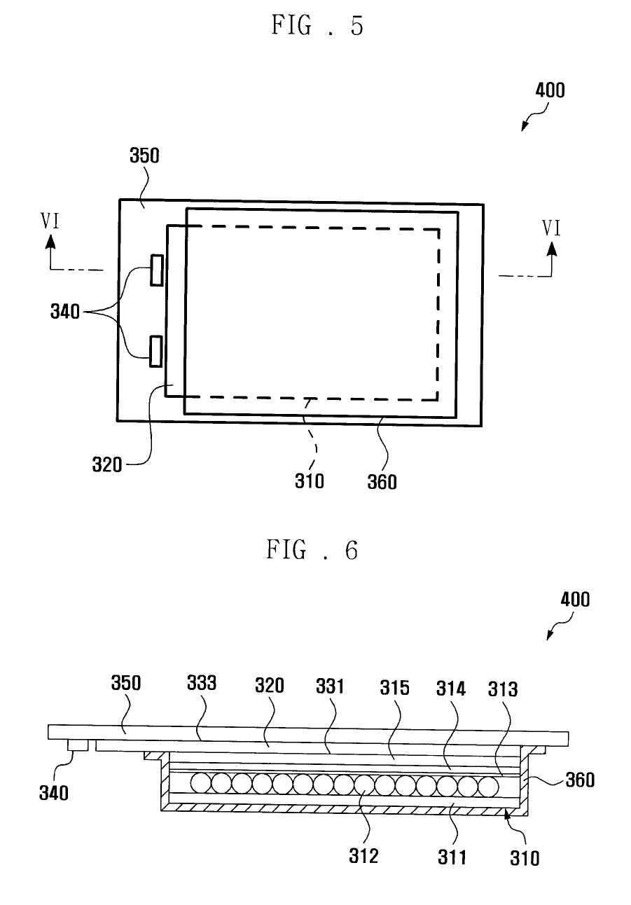

Now referring to FIGS. 5 and 6, a reflection type display apparatus 400 having an FLU according to a fourth exemplary embodiment has a structure that a display panel 310 is attached to a light guide 320 through a first adhesive layer 331, and the light guide 320 is attached to a protection window 350 through a second adhesive layer 333, as in the third exemplary embodiment. Furthermore, the display panel 310 installed on the lower surface of the protection window 350 and the outer side surfaces of the light guide 320 are covered by a moisture-proof light-shield film 360.

The display panel 310 preferably comprises an electronic paper of an electrophoresis type, including a transparent substrate 314 having a lower surface plated with a transparent electrode 313, an electronic ink layer 312 coated on the lower surface of the transparent substrate 314, and an electrode substrate 311 attached to the lower part of the electronic ink layer 312. Further, an upper moisture-proof film 315 is attached to the upper surface of the transparent substrate 314.

As can be seen from FIG. 6, the moisture-proof light-shield film 360 covers the exposed surfaces of the light guide 320 and the display panel 310 excluding a side surface of the light guide 320 installed with the light source 340, and the edges of the moisture-proof and light-shield film 360 are attached to the lower surface of the protection window 350. In particular, the moisture-proof and light-shield film 360 is attached to the lower surface of the electrode substrate 311 of the display panel 310, and is thereby provides a lower moisture-proof film. The moisture-proof and light-shield film 360 is opaque, thereby preventing the incident light emitted to a side of the light guide 320 from leaking out through the opposite side of the light guide 320.

Because the moisture-proof light-shield film 360 is located under the display panel 310, an opaque material can be used, and further a plastic film containing a metal layer may be used for better moisture-proofing and light-shielding characteristics of the moisture-proof light-shield film 360. The metal layer may comprise an aluminum material in a foil form, or other suitable material.

The light source 340 and the side surface of the light guide 320 adjacent to the light source 340 are located outside the moisture-proof light-shield film 360. Further, a portion of the side surface of the light guide 320 facing the light source 340 may protrude outside of the display panel 310. The outer surface of the display panel 310 and the outer side surfaces of the light guide 320 excluding the protruding portion of the light guide 320 are covered by the moisture-proof light-shield film 360.

An example in which the display panel 310 has no separate lower moisture-proof film and the moisture-proof and light-shield film 360 takes a role of a lower moisture-proof film is disclosed. However, similar to the display panel disclosed in the first exemplary embodiment, a lower moisture-proof film may further be formed on the lower surface of the electrode substrate 311. In this case, the moisture-proof and light-shield film 360 is disposed under the lower moisture-proof film.

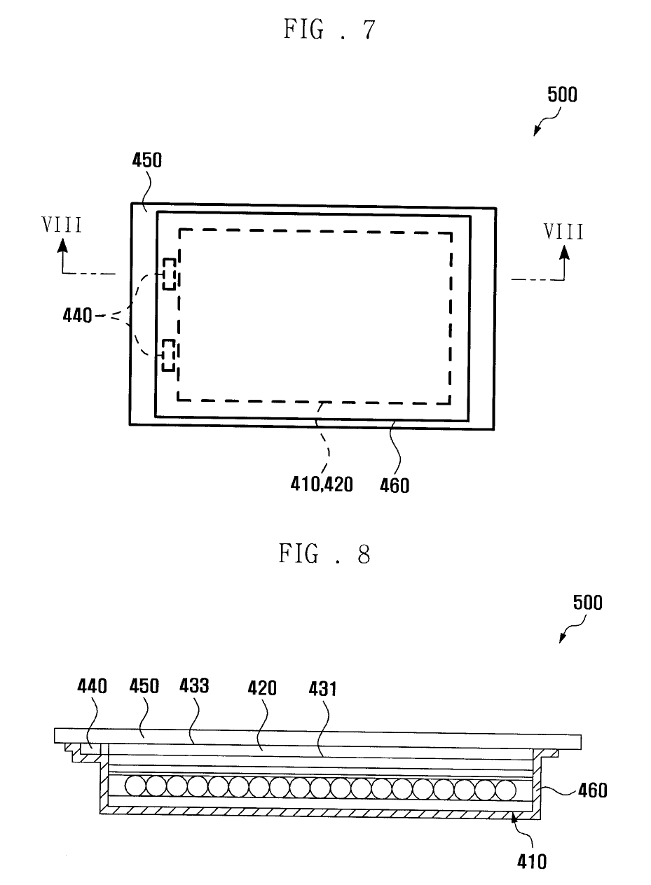

In the fourth exemplary embodiment, a reflection type display apparatus has a structure that the moisture-proof light-shield film does not cover the light source and a portion of the side surface adjacent to the light source. However, in another exemplary embodiment, the structure may be provided in a covered form, one particular example of which is shown in FIGS. 7 and 8.

Referring to FIGS. 7 and 8, a reflection type display apparatus 500 having an FLU according a fifth exemplary embodiment has a structure that a display panel 410, a light guide 420, and a light source 440 are covered by a moisture-proof light-shield film 460.

The display panel 410 may comprise, for example, a liquid crystal panel or an electronic paper, just to name two possibilities. In the case that an electronic paper of an electrophoresis type is used, the structure of the display panels illustrated in FIG. 1 or 6 may be utilized.

The reflection type display apparatus 500 according to the fifth exemplary embodiment has a structure that the display panel 410 attached to the light guide 420 through a first adhesive layer 431 and the light guide 420 is attached to the protection window 450 through a second adhesive layer 433, and the display panel 410, light guide 420, and light source 440 installed under the lower surface of the protection window 450 are covered by the moisture-proof light-shield film 460, resulting in nearly identical effects to those of the reflection type display apparatuses 300 and 400 according to the third and fourth exemplary embodiments, respectively.

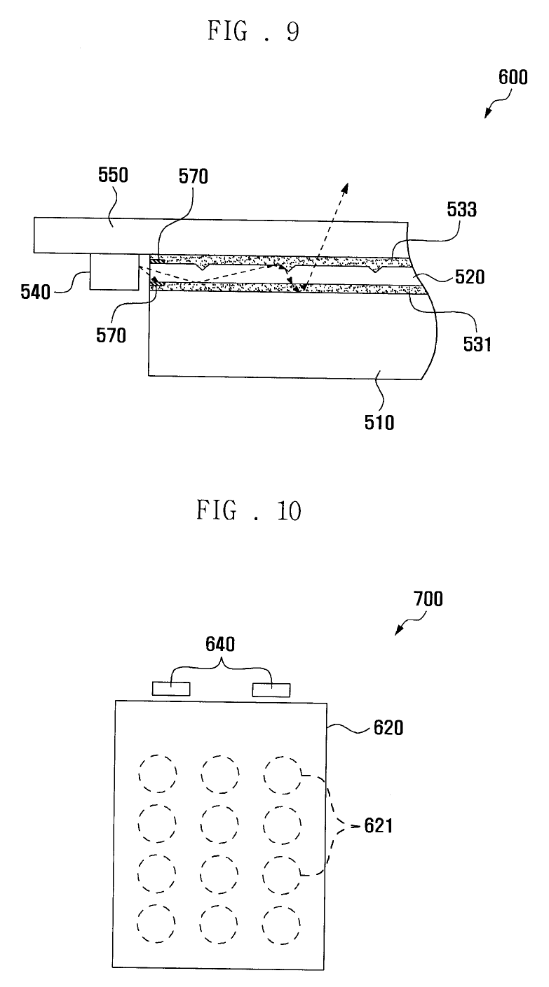

Referring now to FIG. 9, a reflection type display apparatus 600 having an FLU according to a sixth exemplary embodiment has a structure that a display panel 510 is attached to a light guide 520 through a first adhesive layer 531, and the light guide 520 is attached to a protection window 550 through a second adhesive layer 533, similar to the third exemplary embodiment. Further, a light absorption layer 570 is formed at the edges of the upper and lower surfaces of the light guide 520 adjacent to the light source 540.

A portion of light emitted by the light source 540 is not guided into the light guide 520 and leaks to the outside, especially through the edge of the light guide 520 adjacent to the light source 540. Accordingly, a hot spot phenomenon in which the edge of the light guide 520 adjacent to the light source 540 appear brighter than any other part of the light guide 520.

Generation of a hot spot at the edge of the light guide 520 may be inhibited by forming a light absorption layer 570 at the edges of the upper and lower surfaces of the light guide 520. The light absorption layer 570 is formed by coating light absorption ink on the edge of the upper and lower surfaces of the light guide 520. The light absorption layer 570 may be formed, for example, at the whole edge of the upper and lower surfaces of the light guide 520, or may be formed at a portion of the edge of the upper and lower surfaces of the light guide 520 adjacent to the light source 540.

Referring now to FIG. 10, a reflection type display apparatus 700 having an FLU according to a seventh exemplary embodiment includes a light source 640 and a light guide 620. A reflection pattern 621 is formed in the light guide 620 only in a specific area where illumination is desired. A display panel, the light guide 620, and a protection window may be disposed in a structure similar to those of the first to sixth exemplary embodiment.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A reflection type display apparatus comprising:
a display panel;
a light guide disposed on the upper surface of the display panel;
a light transparent first adhesive layer arranged between the light guide and the display panel for attaching the lower surface of the light guide to the upper surface of the display panel; and
a light source located at a side of the light guide and for emitting light to the light guide.

2. The reflection type display apparatus of claim 1, wherein the display panel and light guide are comprised of a flexible material, and a thickness of the first adhesive layer remains constant regardless of an amount of deformation of the display apparatus.

3. The reflection type display apparatus of claim 1, wherein a reflection pattern is formed on at least one of the lower surface and the upper surface of the light guide.

4. The reflection type display apparatus of claim 3, wherein the first adhesive layer has a refractive index which is less than a refractive index of the light guide.

5. The reflection type display apparatus of claim 3, further comprising a protection window installed on the upper surface of the light guide.

6. The reflection type display apparatus of claim 5, wherein the protection window is installed maintaining a predetermined distance from the upper surface of the light guide.

7. The reflection type display apparatus of claim 5, further comprising a light transparent second adhesive layer attaching the lower surface of the protection window to the upper surface of the light guide.

8. The reflection type display apparatus of claim 7, wherein the second adhesive layer has a refractive index less than the refractive index of the light guide.

9. The reflection type display apparatus of claim 7, wherein the display panel, the light guide, and the protection window are comprised of a flexible material, and a thickness of the first adhesive layer and the second adhesive layer remains constant upon deformation of the display apparatus.

10. The reflection type display apparatus of claim 7, further comprising a moisture-proof light-shield film covering the display panel installed on the lower surface of the protection window and the outer side surfaces of the light guide.

11. The reflection type display apparatus of claim 10, wherein the moisture-proof light-shield film further covers the light source and the outer side surfaces of the light guide installed with the light source.

12. The reflection type display apparatus of claim 10, wherein the moisture-proof light-shield film is a plastic film containing a metal layer.

13. The reflection type display apparatus of claim 7, wherein a light absorption layer is formed at the edges of the upper and lower surfaces of the light guide adjacent to the light source.

14. The reflection type display apparatus of claim 13, wherein the display panel comprises an electronic paper.

15. The reflection type display apparatus of claim 3, wherein the reflection pattern is formed in an area for illumination of the display panel.

16. The reflection type display apparatus of claim 15, wherein the reflection pattern is formed by a hot stamping method.

17. A reflection type display apparatus comprising:
a display panel;
a light guide disposed for maintaining a predetermined distance from an upper surface of the display panel;
a light source located at a lateral side of the light guide for emitting light to the light guide;
a protection window disposed on an upper surface of the light guide; and
a light transparent adhesive layer attaching a lower surface of the protection window to the upper surface of the light guide.

18. The reflection type display apparatus of claim 17, wherein a reflection pattern is formed on at least one of the lower surface and the upper surface of the light guide.

19. The reflection type display apparatus of claim 18, wherein the adhesive layer has a refractive index which is less than the refractive index of the light guide.

20. The reflection type display apparatus of claim 18, wherein a light absorption layer is formed at the edges of the upper and lower surfaces of the light guide adjacent the light source.

21. The reflection type display apparatus of claim 17, wherein the display panel comprises an electronic paper.

22. The reflection type display apparatus of claim 18, wherein the reflection pattern is formed in an area for illumination of the display panel.

23. The reflection type display apparatus of claim 22, wherein the reflection pattern is formed by a hot stamping method.
